(19) United States
(12) Patent Application Publication
(10) Pub. No.: US 2008/0043081 A1
(43) Pub. Date: Feb. 21, 2008

(54) Active Ray Curable Ink-Jet Ink; And Image Forming Method And Ink-Jet Recording Apparatus Using The Same

(76) Inventors: Satoshi Masumi, Kanagawa (JP); Daisuke Ishibashi, Tokyo (JP)

Correspondence Address: CANTOR COLBURN, LLP, 55 GRIFFIN ROAD SOUTH, BLOOMFIELD, CT, 06002, US

(21) Appl. No.: 11/794,834

(22) PCT Filed: Dec. 12, 2005
(86) PCT No.: PCT/JP05/22745

§ 371 Date: Jul. 6, 2007

(30) Foreign Application Priority Data
Jan. 11, 2005 (JP) 2005-003535

(51) Int. Cl. B41J 2/01; C09D 11/02

(52) U.S. Cl. 347/102; 106/31.9

(57) ABSTRACT

The present invention provides an active ray curable ink-jet ink which exhibits excellent ejection capability, results in no mixing of deposited dots between colors during high speed printing, and exhibits rapid curing characteristics, and an image forming method and an image forming apparatus employing the above ink-jet ink. The above active ray curable ink-jet ink is characterized of incorporating at least a carbon black based pigment, a dispersing agent, a cationic polymerizable monomer, and an acid generating agent, wherein the aforesaid carbon black based pigment is basic and the aforesaid dispersing agent has an acid value and an amine value.

### TECHNICAL FIELD

The present invention relates to an active ray curable ink-jet ink capable of stably reproducing highly detailed images on various recording media, and an image forming method and an ink-jet recording apparatus using the same.

### BACKGROUND

In recent years, ink-jet recording systems, which enable simple formation of images at low cost, have been applied to printing fields such as photography, various types of printing, and special printing such as marking and color filters. Specifically, by employing ink-jet recording apparatuses which eject controlled minute dots of ink, ink-jet inks which have been improved in color reproduction, durability, and ejection adaptability, and specialized paper media which have been enhanced in color forming properties of colorants and surface glossiness, it has become possible to achieve image quality comparable to conventional silver halide photography. Image quality of the present ink-jet recording systems is enhanced only when an ink-jet recording apparatus, an ink-jet ink and a specialized paper medium are simultaneously improved.

However, ink-jet systems which require specialized kinds of paper result in problems such that the recording media are limited and using such recording media increases cost. Accordingly, many trials have been made in which recording, employing the ink-jet systems, is carried out on transfer media of differing specialized kinds of paper. Specific systems include a phase-changing ink-jet system employing a wax ink which is solid at room temperature, a solvent based ink-jet system employing, as a main component, rapidly drying organic solvents, and an actinic radiation curable ink-jet system in which, after recording, active rays such as ultraviolet rays (UV radiation) are exposed onto the deposited ink to result in crosslinking.

Of these, the UV ray curable ink-jet system results in relatively low unpleasant odor, compared to a solvent based ink-jet system. One example of the ultraviolet ray curable ink-jet inks is disclosed for example in Unexamined Japanese Patent Application No. (hereinafter, referred to as JP-A) 6-200204 and Japanese Translation of PCT International Application Publication No. 2000-504778.

However, even though these active ray curable ink-jet inks are employed, the dot diameter after deposition of ink droplets markedly varies, whereby it has been impossible to consistently form highly detailed images on various recording media in various working environments.

In recent years, a number of ultraviolet ray curable ink-jet inks, employing cationic polymerizable monomers, have been proposed. Such ultraviolet radiation curable ink-jet inks are not subjected to inhibition due to oxygen, but result in a problem in which they tend to be adversely affected by molecular level moisture (namely humidity). Further, depending on the ambience during curing, a problem occurs in which wrinkling is generated due to contraction during curing.

Image formation via the ultraviolet ray curable ink-jet system is characterized in that it is possible to produce high quality images at low cost and to form images onto recording media which absorb no ink. However, inherent problems of the above ultraviolet ray curable ink-jet system result. For example, in cases in which images are formed on recording media which absorb no ink, when the curing capability of an ink is insufficient, image quality is markedly degraded due to mixing of a deposited dot with adjacent dots. Specifically, when formation of highly detailed images is demanded, mixing of colors of deposited ink dots results in critical problems.

On the other hand, regarding ultraviolet radiation curable ink-jet inks, disclosed are active ray curable ink-jet inks which employ, as a photopolymerizable compound, oxirane compounds, vinyl ether compounds, and oxetane compounds (refer, for example, to Patent Documents 1 and 2). Further disclosed are active ray curable ink-jet inks which employ, as a photopolymerizable compound, alicyclic epoxy compounds and oxetane compounds (refer, for example, to Patent Documents 3 and 4. However, in each of the above proposed methods, dot bleeding has not been sufficiently countered.

In common aqueous ink-jet systems, the above drawback has been countered by enhancing ink penetration into recording media via incorporated additives into specialized paper and ink to exhibit various functions. However, in ultraviolet ray curable ink-jet systems, no countering method has been found for the image forming method applied to recording media exhibiting no ink absorbability. Further, in high speed printing, formed image carrying media are frequently wound. Due to that, it has been demanded to develop an active ray curable ink-jet ink which results in quick curing of formed images.

(Patent Document 1) JP-A 2001-220526 (claims and examples)

(Patent Document 2) JP-A 2002-188025 (claims and examples)

(Patent Document 3) JP-A 2002-317139 (claims and examples)

(Patent Document 4) JP-A 2003-55449 (claims and examples)

### DISCLOSURE OF THE INVENTION

### Problems to be Dissolved by the Invention

In view of the foregoing, the present invention was achieved. An object of the present invention is to provide an active ray curable ink-jet ink which exhibits excellent ejection capability, results in no mixing of deposited dots between colors during high speed printing, and exhibits rapid curing characteristics, and an image forming method and an image forming apparatus employing the aforesaid ink-jet ink.

### Means for Solving the Problems

The above object of the present invention was achieved via the following embodiments.

(Item 1)

An active ray curable ink-jet ink comprising at least a carbon black based pigment, a dispersing agent, a cationic polymerizable monomer, and an acid generating agent,

wherein the carbon black based pigment is basic, and the dispersing agent has an acid value and an amine value.

(Item 2)

The active ray curable ink-jet ink described in item 1,

wherein the acid value and amine value satisfy a condition of the following formula.
0.3≦(amine value of dispersing agent)/(acid value of dispersing agent)≦3.3

(Item 3)

The active ray curable ink-jet ink described in item 1 or 2,

wherein at least one of the cationic polymerizable monomers is a compound having an oxetane ring.

(Item 4)

The active ray curable ink-jet ink described in any one of items 1-3,

wherein at least one of the cationic polymerizable monomers is a compound having an oxirane ring.

(Item 5)

The active ray curable ink-jet ink described in item 4,

wherein the compound having an oxirane ring is the compound represented by Formula (1).

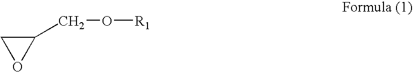

In Formula (1), R₁ is an alkyl group having 1-10 carbon atoms which may be substituted, an aromatic group which may be substituted, or an acyl group.

(Item 6)

The active ray curable ink-jet ink described in item 4,

wherein the compound having an oxirane ring is the compound represented by Formula (2).

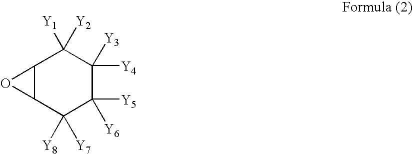

In Formula (2), Y₁-Y₈ are each a hydrogen atom, an alkyl group, a carbonyl group, or an ether group, which groups may be substituted, and Y₁-Y₈ may differ with each other.

(Item 7)

The active ray curable ink-jet ink described in item 4,

wherein the compound having an oxirane ring is α-pinene oxide.

(Item 8)

The active ray curable ink-jet ink described in item 4,

wherein the compound having an oxirane ring is 1,2:8,9-diepoxylimonene.

(Item 9)

The active ray curable ink-jet ink described in item 4,

wherein the compound having an oxirane ring is epoxidized vegetable oil having an unsaturated bond.

(Item 10)

The active ray curable ink-jet ink described in item 4,

wherein the compound having an oxirane ring is the compound represented by Formula (A).

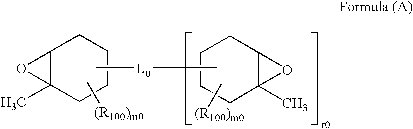

In Formula (A), R₁₀₀ is a substituent, m0 is 0-2, r0 is 1-3, and L₀ are each an r0+1 valent linking group having 1-15 carbon atoms, which may incorporate an oxygen atom or a sulfur atom in the primary chain, or a single bond group.

(Item 11)

An image forming method comprising the steps of:

(a) ejecting the active ray curable ink-jet ink described in any one of items 1-10 onto a recording medium from an ink-jet recording head, and

(b) curing the ejected ink-jet ink to form an image onto the recording medium,

wherein actinic rays are exposed during 0.001-1 second after the active ray curable ink-jet ink is deposited onto the recording medium.

(Item 12)

The image forming method described in item 11,

wherein actinic rays are exposed after the active ray curable ink-jet ink is deposited onto the recording medium, and a total thickness of an ink layer after curing is 2-25 μm.

(Item 13)

The image forming method described in item 11,

wherein the droplet volume of the active ray curable ink-jet ink ejected from each nozzle of the ink-jet recording head is 2-20 pl.

(Item 14)

The image forming method described in any one of items 11-13,

wherein the ink-jet recording head is a line head system.

(Item 15)

An ink-jet recording apparatus which is employed in the image forming method described in any one of items 11-14,

wherein the active ray curable ink-jet ink is ejected after the active ray curable ink-jet ink and the ink-jet recording head are heated at 35-100° C.

### EFFECTS OF THE INVENTION

Based on the present invention, it has become possible to provide an active ray curable ink-jet ink which exhibits excellent ejection capability, results in no mixing of deposited dots between colors even during high speed printing, and exhibits rapid curing characteristics, and an image forming method and an image forming apparatus employing the aforesaid ink-jet ink.

### BRIEF DESCRIPTION OF THE DRAWINGS

FIG. 1 is a front view showing one example of the structure of the main section of an ink-jet recording apparatus.

FIG. 2 is a top view showing another example of the structure of the thio main section of an ink-jet recording layer.

### DESCRIPTION OF THE DESIGNATIONS

1: ink-jet recording apparatus
2: head carriage
3: ink-jet recording head
31: ink ejection orifice
4: exposure means
5: platen section
6: guide member
7: bellow structure
P: recording medium

### DESCRIPTION OF THE PREFERRED EMBODIMENTS

Preferred embodiments to practice the present invention will now be described, however, the present invention is not limited thereto.

The present invention will now be detailed.

In view of the above problems, the inventors of the present invention conducted diligent investigations. As a result, the following was discovered, whereby the present invention was achieved. In an active ray curable ink-jet ink which incorporates at least a carbon black based pigment, a dispersing agent, a cationic polymerizable monomer, and an acid generating agent, by employing an active ray curable ink-jet ink in which the carbon black based pigment is basic and the dispersing agent has an acid value and an amine value, an active ray curable ink-jet ink was realized which exhibited excellent ejection capability, resulted in no mixing of deposited dots between colors even during high speed printing, and exhibited rapid curing characteristics.

Initially, carbon black based pigments, which are used as colorants, will be described.

In view of retention properties of ink, carbon black based pigments, which are employable in the present invention, are preferably basic. It is possible to determine basicity, as described herein, employing the common methods known in the art, such as pH determination.

For example, the pH of carbon black based pigments is determined as follows. Namely, a carbon black based pigment of an appropriate amount is weighed and placed in a beaker. After adding water at a ratio of 10 ml per 1 g of the carbon black based pigment, the resulting mixture is boiled over 15 minutes. In order to make the pigment more wettable, few drops of ethyl alcohol may be added. After boiling, the mixture is cooled to room temperature. Subsequently, the supernatant is removed via a decantation or centrifugal method so that a muddy product remains. A glass electrode is inserted into the resulting muddy product and the pH is determined. Points requiring special attention during the determination are as follows. Since the determined value occasionally fluctuates depending on where the electrode is inserted, it is recommended that the beaker be moved so that the electrode surface is sufficiently brought into contact with the surface of the muddy product and when the pH value remains constant, that determination value is read.

Problems of the active ray curable ink-jet ink (hereinafter, also referred to simply as the ink) during ejection include poor ink ejection. Causes of such poor ink ejection include clogging due to an increase in viscosity due to polymers formed via a dark reaction during an extended period of storage, or a state at a relatively high temperature and formation of foreign matter. JP-A Nos. 2003-55563, 2002-188025, and 2003-285546 disclose ink-jet inks employing cationic polymerizable monomers, but do not describe any of the dark reaction.

The dark reaction is not limited to the case in which the ink is stored over an extended period. The active ray curable ink-jet ink exhibits a higher viscosity than an aqueous ink-jet ink due to its monomer composition and is frequently ejected after decreasing the viscosity while heated. Even in such a case, poor ejection tends to occur.

In the ink of the present invention, the reason, in which basic carbon black is preferred as a colorant, is assumed to be that the above dark reaction is retarded. Since the ink of the present invention undergoes curing via cationic polymerizable monomers, it is assumed that acidic substances in the ink induce the dark reaction, and acidic carbon black accelerates the dark reaction, resulting in poor ejection.

Employed as basic carbon black are those known in the art, examples of which include #2300, #990, #980, #960, #950, #900, #850, MCF88, #750B, #650B, MAS600, #4000B, #4350B, #52, #47, #45, #45L, #44, #33, #32, #30, #25, #20, #10, #5, CF9, #95, #85, #260, #3050B, and #3350B, all produced by Mitsubishi Chemical Corp., as well as PRINTEX 95, PRINTEX 90, PRINTEX 85, PRINTEX 75, PRINTEX 55, PRINTEX 45, PRINTEX 40, PRINTEX P, PRINTEX 60, PRINTEX L6, PRINTEX L, PRINTEX 300, PRINTEX 30, PRINTEX 35, PRINTEX 25, PRINTEX 200, PRINTEX A, PRINTEX G, and SPECIAL BLACK 101, all produced by Degussa AG.

Further, preferred as the carbon black according to the invention is one which exhibits a relatively large BET specific surface area, such as 50-300 m²/g, and a relatively small particle diameter. When the BET specific surface area exceeds 300 m²/g, dispersion stability tends to deteriorate due to the excessive small diameter of pigment particles, while when it is less than 50 m²/g, ejection tends to be unstable due to the large diameter of pigment particles.

BET specific surface area, as described in the present invention, is determined via a method in which the specific surface area of particles is calculated employing a gas adsorption method, which is conducted as follows. Molecules of gas such as nitrogen, the adsorption population of which is known, is adsorbed onto particles, and the specific surface area is calculated based on the resulting adsorption amount. The BET specific surface area is employed to precisely calculate the amount (being the adsorption amount of a monomolecular layer) of gas molecules which are directly adsorbed onto a solid surface and is calculated based on the following numeric formula called BET equation.

The BET equation is the relationship between adsorption equilibrium pressure P at an adsorption equilibrium state, at a constant temperature and adsorption amount V at the above pressure, and is represented as follows.
P/V(P₀−P)=(1/VmC)+((C−1)/VmC)(P/P₀)

wherein
P₀: saturated vapor pressure;
Vm: monomolecular layer adsorption amount, namely adsorption amount when gas molecules are formed as the monomolecular layer; and
C: parameter (>0) related to heat of adsorption.

Monomolecular adsorption amount Vm is calculated based on the above formula whereby it is possible to obtain the surface area of particles by multiplying the calculated value by the sectional area occupied by one gas molecule.

The specific determination method of the BET specific surface area is as follows. For example, after a pre-treatment of degassing a sample at 60° C. for 10 hours, determination is carried out in the use of nitrogen gas as an adsorption gas employing a gas adsorption meter. Automatic gas adsorption meters include AUTOSORB 1 (manufactured by Yuasa-Ionics Co., Ltd.) and FLOWSORB 2300 (manufactured by Shimadzu Corp.). In these meters, the BET specific surface area is obtained based on the one point method or the multipoint method in the nitrogen adsorption method.

Further, a DBP absorption amount is preferably 50-150 ml/100 g, but is more preferably 50-100 ml/100 g.

Still further, the above DBP (dibutyl phthalate) absorption amount is determined as follows. DBP is added little by little to 100 g of a carbon black based pigment. While kneading the resulting mixture, the state of the pigment is observed. When a discretely dispersed state is modified into the form of agglomerate, the volume of DBP in ml is designated as the DBP absorption amount.

Further, in addition to the above commercial carbon blacks, employed may be conventional ones described in various references, which include Color Index (edited by The Society of Dyers and Colorists), “Kaitei Shinban Ganryo Binran (Revised New Edition Pigment Handbook)”, edited by Nippon Ganryo Gijutsu Kyokai (published in 1989); “Saishin Ganryo Oyo Gijutsu (Most Recent Pigment Application Technology)”, CMC Shuppan (published in 1986); “Insatsu Ink Technology (Printing Ink Technology)”, CMC Shuppan (published in 1984); and W. Herbst and K. Hunger, Industrial Organic Pigments (VCH Verlagsgesellschaft, published in 1993).

To disperse the above pigments, it is possible to employ, for example, a ball mill, a sand mill, an attritor, a roller mill, an agitator, a Henschel mill, a colloid mill, an ultrasonic homogenizer, a pearl mill, a wet system jet mill, or a paint shaker.

The feature of the dispersing agents according to the present invention is that they have an acid value as well as an amine value. It is possible to determine the acid value or the amine value, as described in the present invention, employing methods known in the art, such as potentiometric titration. For example, it is possible to determine them based on the method described in Shikizai Kyokai Shi, 61, [12] 692-698 (1988).

Examples of dispersing agents having an acid value and an amine value include DA-234, DA-325, DA-703-50, and DA-7300, all produced by Kusumoto Chemicals Ltd.; PB822 and PB821, both produced by Ajinomoto Fine-Techno Co., Inc.; EFKA-4300, EFKA-7411, EFKA-7476, EFKA-5244, EFKA-6220, EFKA-6225, EFKA-7544, and EFKA-7564, all produced by EFKA Additives B. V.; DISPERBYK-109, DISPERBYK-106, and DISPERBYK-161, all produced by Big Chemie Co.; and HINOACT-8000 and HINOACT-6000, both produced by Kawaken Fine Chemical Co., Ltd. Of these, dispersing agents are preferred which have a greater acid value than an amine value.

In the present invention, the amine value and the acid value of dispersing agents were determined as follows.

<Determination of Amine Value of Dispersing Agent>

A dispersing agent was dissolved in methyl isobutyl ketone, and the resulting solution was subjected to potentiometric titration employing a 0.01 mol/L perchloric acid methyl isobutyl ketone solution. The determined value was converted in terms of KOH mg/g and the resulting value was designated as the amine value. The above measurement via potentiometric titration was carried out employing automatic titrator COM-1500, manufactured by Hiranuma Sangyo Co., Ltd.

<Determination of Acid Value of Dispersing Agent>

A dispersing agent was dissolved in methyl isobutyl ketone, and the resulting solution was subjected to potentiometric titration, employing a 0.01 mol/L potassium methoxide-methyl isobutyl ketone/methanol (4:1) solution. The determined value was converted in terms of KOH mg/g, and the resulting value was designated as the acid value. Potentiometric titration was carried out employing automatic titrator COM-1500, manufactured by Hiranuma Sangyo Co., Ltd.

It is assumed that by employing dispersing agents which have both an acid and amine value, adsorption is effectively performed onto both the acidic and basic portions on the surface of carbon black based pigments.

Further, dispersing agents are preferred in which the acid and amine values satisfy the following relationship.
0.3≦(amine value of dispersing agent)/(acid value of dispersing agent)≦3.3

The added amount of the dispersing agents according to the present invention is preferably 10-100 parts with respect to 100 parts of the carbon black based pigments, but is more preferably 20-80 parts.

Dispersing agents commonly have polar groups to be adsorbed onto pigments. Since their excessive presence degrades curability, the added amount specified above is preferred.

In active ray curable ink-jet inks, solvents or polymerizable monomers are commonly employed as a dispersion medium. However, in the active ray curable ink-jet ink of the present invention, in order to enable rapid reaction/curing, it is preferable that no solvents be employed. When solvents remain in cured images, solvent resistance is deteriorated and the VOC problem of residual solvents occurs. Consequently, in the ink of the present invention, in view of dispersion adaptability, it is preferable that as dispersion media, solvents are not employed, but polymerizable monomers, especially those exhibiting the lowest viscosity are selected and then employed.

It is preferable that employed dispersing agents are dissolved in dispersion media and then employed. It is more preferable that they are dissolved in polymerizable monomers and then employed.

Further, synergists may be employed as a dispersion aid. Synergists, as described herein, refer to organic compounds which have a structure similar to pigments and further have a dye or a organic pigment modified by a polar group such as an acidic group or a basic group in which a polar group is linked directly or via a joint. It is possible to enhance the dispersibility of pigments in such a manner that the above synergists are adsorbed onto the surface of pigments and allowed to bond to dispersing agents.

UV absorbers are specifically effective for ink which has been subjected to enhancement of pigment dispersibility via treatment of the surface of pigments employing synergists. Preferred synergists include those which are subjected to acid modification such as sulfonic acid modification or carboxyl group modification, and have an amine value greater than the acid value.

Examples of dispersing aids include EFKA-6745 and EFKA-6750, produced by EFKA Additives B. V., and SOLSPERSE 5000, SOLSPERSE 12000, and SOLSPERSE 22000, produced by Avicia Ltd. The added amount of the dispersing aids is preferably 1-10 parts with respect to 100 parts of the pigments.

With regard to dispersion of pigments, pigments dispersing agents, and dispersion media are selected, and dispersing conditions and filtering conditions are appropriately set so that the average diameter of carbon black based pigment particles is preferably controlled to 0.06-0.5 μm. and the maximum particle diameter is 0.3-5 μm but is preferably 0.3-3 μm. Via the above particle diameter management, it is possible to minimize clogging of nozzles in an ink-jet recording head and to maintain good storage stability, transparency, and curing rate of the ink. The concentration of pigments is preferably 1-10% by weight with respect to the total ink weight.

<Cationic Polymerizable Compounds>

Cationic polymerizable monomers according to the present invention are cationic polymerizable compounds such as (1) compounds having oxirane rings, (2) styrene derivatives, (3) vinylnaphthalene derivatives, (4) vinyl ethers, (5) N-vinyl compounds, and (6) oxetane compounds.

(1) Compounds Having Oxirane Rings

Examples of the compounds having oxirane rings include prepolymers having at least two oxirane rings in a molecule. Examples of these prepolymers include alicyclic polyepoxides, polyglycidyl esters of polybasic acid, polyglycidyl ethers of polyhydric alcohol, polyglycidyl ethers of polyoxyalkylene glycol, polyglycidyl ethers of aromatic polyol, compounds formed by hydrogenating polyglycidyl ethers of aromatic polyol, urethane polyepoxy compounds, and epoxidized polybutadienes. These prepolymers may be used individually or in combination of at least two types.

(2) Styrene Derivatives

Examples include styrene, p-methylstyrene, p-methoxystyrene, β-methylstyrene, p-methyl-β-methylstyrene, α-methylstyrene, and p-methoxy-β-methylstyrene.

(3) Vinylnaphthalene Derivatives

Examples include 1-vinylnaphthalene, α-methyl-1-vinylnaphthalene, β-methyl-1-vinylnaphthalene, 4-methyl-1-vinylnaphthalene, and 4-methoxy-1-vinylnaphthalene.

(4) Vinyl Ethers

Examples include isobutyl ether, ethyl vinyl ether, phenyl vinyl ether, p-methylphenyl vinyl ether, p-methoxyphenyl vinyl ether, α-methylphenyl vinyl ether, β-methylisobutyl vinyl ether, and β-chloroisobutyl vinyl ether

(5) N-Vinyl Compounds

Examples include N-vinylcarbazole, N-vinylpyrrolidone, N-vinylindole, N-vinylpyrrole, N-vinylphenothiazine, N-vinylacetoanilide, N-vinylethylacetamide, N-vinylsuccinimide, N-vinylphthalimide, N-vinylcaprolactam, and N-vinylimidazole.

(6) Oxetane Compounds

It is possible to use any of the oxetane compounds, being compounds having oxetane rings, known in the art, as disclosed in JP-A Nos. 2001-220526 and 2001-310937.

The oxetane compounds are preferably used as the cationic polymerizable monomer, but the oxetane compounds having oxirane rings are more preferable.

Preferred examples of the compounds having oxirane rings include the compounds represented by above Formulas (1) and (2), α-pinene oxide, 1,2:8,9-diepoxylimonene, epoxidized vegetable oil having unsaturated bonds, and the compounds represented by above Formula (A).

The compounds having an oxirane ring represented by above Formula (1) will now be described. In above Formula (1), R₁ is a substitutable alkyl group having 1-10 carbon atoms (for example, substitutable methyl, ethyl, propyl, butyl, isopropyl, t-butyl, hexyl, 2-ethylhexyl, and benzyl groups), a substitutable aromatic group (for example, substitutable phenyl and naphthyl groups), and a substitutable acyl group (for example, a benzoyl group, a methacryl group, and a stearyl group). Of these, an alkyl group is preferable.

The specific examples of the compounds represented by Formula (1) will now be listed, however, the present invention is not limited thereto.

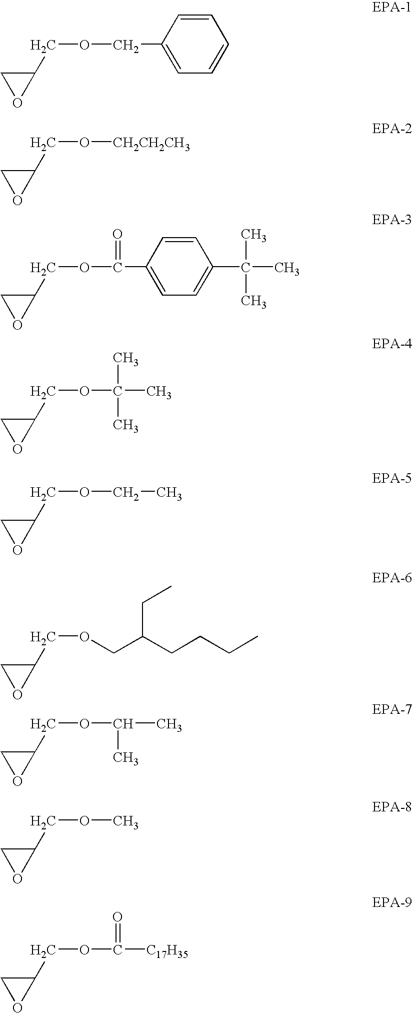

Further, the compounds having an oxirane ring represented by Formula (2) will now be described. In above Formula (2), Y₁-Y₈ each, which may differ, represent a hydrogen atom, a substitutable alkyl group (for example, substitutable methyl, ethyl, propyl, butyl, isopropyl, t-butyl, hexyl, 2-ethylhexyl, and benzyl groups), a substitutable carbonyl group (for example, substitutable acetyl and benzoyl groups), and an ether group (for example, an alkyl ether group and an aryl ether group).

Preferred examples of the compounds having an oxirane ring represented by Formula (2) include the compounds represented by following Formulas (III) and (IV).

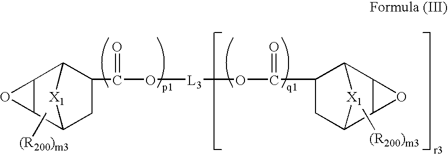

In above Formula (III), R₂₀₀ is an aliphatic group located in any position except for the α or β position of the oxirane ring, and m3 is 0-2. X₁ is —(CH₂)ₙ₀— or —(O)ₙ₀—, and n0 is 0 or 1, while p1 and q1 are each 0 or 1, not being 0 simultaneously. r3 is 1-3. L₃ is a single bond or a (r3+1) valent branched connecting group having 1-15 carbon atoms, which may have an oxygen atom or a sulfur atom in the main chain.

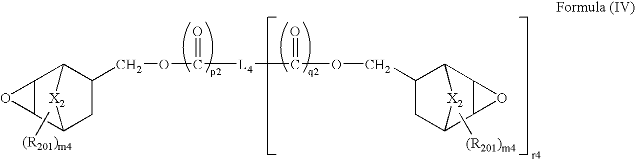

In above Formula (IV), R₂₀₁ is an aliphatic group located in any position except for the α or β position of the oxirane ring, and m4 is 0-2. X₂ is —(CH₂)ₙ₁— or —(O)ₙ₁—, and n1 is 0 or 1, while p2 and q2 are each 0 or 1, not being 0 simultaneously. r4 is 1-3. L₄ is a single bond or a (r4+1) valent branched connecting group having 1-15 carbon atoms, which may have an oxygen atom or a sulfur atom in the main chain.

The compounds having oxirane rings represented by Formula (III) will now be described.

R₂₀₀ is an aliphatic group. Examples of the aliphatic group include an alkyl group having 1-6 carbon atoms (for example, a methyl group, an ethyl group, a propyl group, an isopropyl group, and a butyl group); a cycloalkyl group having 3-6 carbon atoms (for example, a cyclopropyl group, a cyclobutyl group, a cyclopentyl group, and a cyclohexyl group); an alkenyl group having 1-6 carbon atoms (for example, a vinyl group, a 1-propenyl group, a 2-propenyl group, and a 2-butenyl group); and an alkynyl group having 1-6 carbon atoms (for example, an acetylenyl group, a 1-propynyl group, a 2-propynyl group, and a 2-butynyl group). An alkyl group having 1-3 carbon atoms is preferable, but a methyl group and an ethyl group are more preferable.

m3 is 0-2, but is preferably at least 1.

X₁ is —(CH₂)ₙ₀— or —(O)ₙ₀—, and n0 is 0 or 1. Provided n0 is 0, X₁ is not present.

m3 plus n0 is preferably at least 1.

L₃ is a single bond or a (r3+1) valent branched connecting group having 1-15 carbon atoms, which may have an oxygen atom or a sulfur atom in the main chain.

The compounds having oxirane rings represented by Formula (IV) will now be described.

In above Formula (IV), R₂₀₁ is an aliphatic group. Examples of the aliphatic group include an alkyl group having 1-6 carbon atoms (for example, a methyl group, an ethyl group, a propyl group, an isopropyl group, and a butyl group); a cycloalkyl group having 3-6 carbon atoms (for example, a cyclopropyl group, a cyclobutyl group, a cyclopentyl group, and a cyclohexyl group); an alkenyl group having 1-6 carbon atoms (for example, a vinyl group, a 1-propenyl group, a 2-propenyl group, and a 2-butenyl group); and an alkynyl group having 1-6 carbon atoms (for example, an acetylenyl group, a 1-propynyl group, a 2-propynyl group, and a 2-butynyl group). An alkyl group having 1-3 carbon atoms is preferable, but a methyl group and an ethyl group are more preferable.

m4 is 0-2, but is preferably at least 1.

X₂ is —(CH₂)ₙ₁— or —(O)ₙ₁—, and n1 is 0 or 1. Provided n1 is 0, X₂ is not present.

m4 plus n1 is preferably at least 1.

L₄ is a single bond or a (r4+1) valent branched connecting group having 1-15 carbon atoms, which may have an oxygen atom or a sulfur atom in the main chain.

L₃ and L₄ each may have a substituent. Examples of the substituent include a halogen atom (for example, a chlorine atom, a bromine atom, and a fluorine atom); an alkyl group having 1-6 carbon atoms (for example, a methyl group, an ethyl group, a propyl group, an isopropyl group, and a butyl group); an alkoxy group having 1-6 carbon atoms (for example, a methoxy group, an ethoxy group, an n-propoxy group, an isopropoxy group, an n-butoxy group, and a tert-butoxy group); an acyl group (for example, an acetyl group, a propionyl group, and a trifluoroacetyl group); an acyloxy group (for example, an acetoxy group, a propionyloxy group, and a trifluoroacetoxy group); and an alkoxycarbonyl group (for example, a methoxycarbonyl group, an ethoxycarbonyl group, and a tert-butoxycarbonyl group). Preferred examples of the substituent include a halogen atom, an alkyl group, and an alkoxy group.

In Formula (III) or (IV), examples of the divalent connecting groups having 1-15 carbon atoms, which may have an oxygen atom or a sulfur atom in the main chain, include the following groups. These groups may be combined with a plurality of groups of an —O— group, an —S— group, a —CO— group, and a —CS— group.
ethylidene group: >CHCH₃,
isopropylidene group: >C(CH₃)₂,
2,2-dimethyl-1,3-propanediyl group: —CH₂C(CH₃)₂CH₂—,
2,2-dimethoxy-1,3-propanediyl group: —CH₂C(OCH₃)₂CH₂—,
2,2-dimethoxymethyl-1,3-propanediyl group: —CH₂C(CH₂OCH₃)₂CH₂—,
1-methyl-1,3-propanediyl group: —CH(CH₃)CH₂CH₂—,
1,4-dimethyl-3-oxa-1,5-pentanediyl group: —CH(CH₃)CH₂OCH(CH₃)CH₂—,
1,4,7-trimethyl-3,6-dioxa-1,8-octanediyl group: —CH(CH₃)CH₂OCH(CH₃)CH₂OCH(CH₃)CH₂—
5,5-dimethyl-3,7-dioxa-1,9-nonanediyl group: —CH₂CH₂OCH₂C(CH₃)₂CH₂OCH₂CH₂—
5,5-dimethoxy-3,7-dioxa-1,9-nonanediyl group: —CH₂CH₂OCH₂C(OCH₃)₂CH₂OCH₂CH₂—
5,5-dimethoxymethyl-3,7-dioxa-1,9-nonanediyl group: —CH₂CH₂OCH₂C(CH₂OCH₃)₂CH₂OCH₂CH₂—, and
isopropylidenebis-p-phenylene group: -p-C₆H₄—C(CH₃)₂-p-C₆H₄—

Examples of the connecting groups, being trivalent or more, include groups formed by eliminating the necessary number of the hydrogen atoms, which are located in any of the positions of the above divalent connecting groups, and groups formed by combining these aforesaid groups, being trivalent or more, with a plurality of groups of an —O— group, an —S— group, a —CO— group, and a —CS— group.

Specific examples of the compounds represented by Formula (2) will now be listed; however, the present invention is not limited thereto.

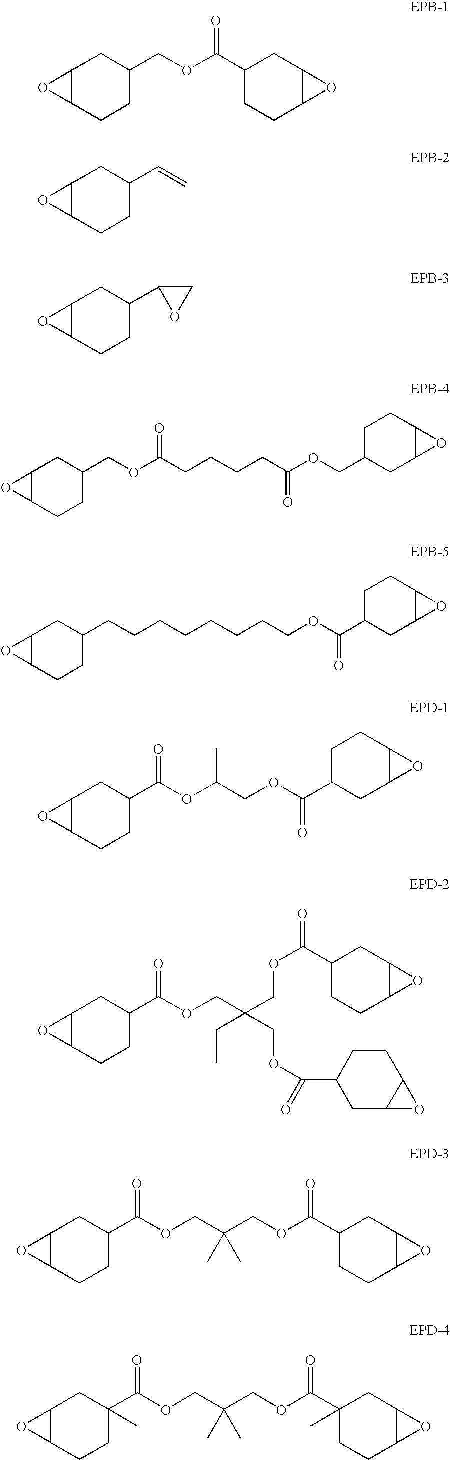

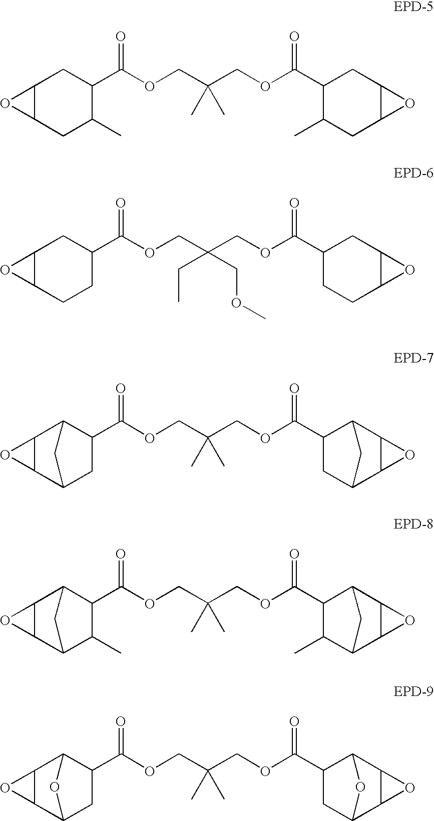

Examples of vegetable oil with epoxidized unsaturated bonds include oil products prepared by epoxidizing vegetable oil having unsaturated bonds such as olive oil, safflower oil, sunflower oil, soybean oil, or linseed oil. Further, epoxidized vegetable oil available on the market may be used. Examples include SANSOClZER E-4030 manufactured by New Japan Chemical Co., Ltd., and Vf7010, Vf9010, and Vf9040 by ATOFINA Chemicals, Inc.

Further, the compounds with oxirane rings represented by above Formula (A) will now be described. In above Formula (A), R₁₀₀ is a substituent. Examples thereof include a halogen atom (for example, a chlorine atom, a bromine atom, and a fluorine atom); an alkyl group having 1-6 carbon atoms (for example, a methyl group, an ethyl group, a propyl group, an isopropyl group, and a butyl group); an alkoxy group having 1-6 carbon atoms (for example, a methoxy group, an ethoxy group, an n-propoxy group, an isopropoxy group, an n-butoxy group, and a tert-butoxy group); an acyl group (for example, an acetyl group, a propionyl group, and a trifluoroacetyl group); an acyloxy group (for example, an acetoxy group, a propionyloxy group, and a trifluoroacetoxy group); and an alkoxycarbonyl group (for example, a methoxycarbonyl group, an ethoxycarbonyl group, and a tert-butoxycarbonyl group). Preferred examples of the substituent include an alkyl group, an alkoxy group, and an alkoxycarbonyl group.

m0 is 0-2, but is preferably 0 or 1.

L₀ is a single bond or a (r0+1) valent connecting group having 1-15 carbon atoms, which may have an oxygen atom or a sulfur atom in the main chain.

Preferred examples of the compounds having oxirane rings represented by Formula (A) include the compounds represented by following Formula (I) or (II).

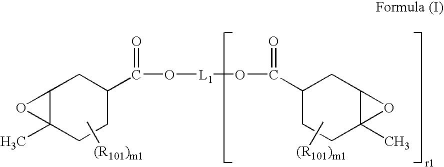

In Formula (I), R₁₀₁ is a substituent, and m1 is 0-2. r1 is 1-3. L₁ is a single bond or a (r1+1) valent connecting group having 1-15 carbon atoms, which may have an oxygen atom or a sulfur atom in the main chain, or a single bond group.

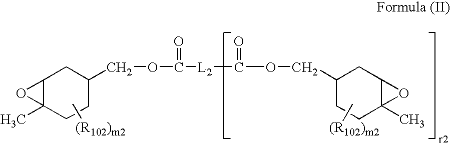

In Formula (II), R₁₀₂ is a substituent, and m2 is 0-2. r2 is 1-3. L₂ is a single bond or a (r2+1) valent connecting group having 1-15 carbon atoms, which may have an oxygen atom or a sulfur atom in the main chain.

Further, the compounds represented by Formula (I) or (II) will now be detailed.

In above Formula (I) or (II), R₁₀₁ and R₁₀₂ are each a substituent. Examples thereof include a halogen atom (for example, a chlorine atom, a bromine atom, and a fluorine atom), an alkyl group having 1-6 carbon atoms (for example, a methyl group, an ethyl-group, a propyl group, an isopropyl group, and a butyl group), an alkoxy group having 1-6 carbon atoms (for example, a methoxy group, an ethoxy group, an n-propoxy group, an isopropoxy group, an n-butoxy group, and a tert-butoxy group), an acyl group (for example, an acetyl group, a propionyl group, and a trifluoroacetyl group), an acyloxy group (for example, an acetoxy group, a propionyloxy group, and a trifluoroacetoxy group), and an alkoxycarbonyl group (for example, a methoxycarbonyl group, an ethoxycarbonyl group, and a tert-butoxycarbonyl group). Preferred examples of the substituent include an alkyl group, an alkoxy group, and an alkoxycarbonyl group.

m1 and m2 are each 0-2, but are preferably 0 or 1.

L₁ is a single bond or a (r1+1) valent connecting group having 1-15 carbon atoms, which may have an oxygen atom or a sulfur atom in the main chain. L₂ is a single bond or a (r2+1) valent connecting group having 1-15 carbon atoms, which may have an oxygen atom or a sulfur atom in the main chain.

In Formulas (A), (I), and (II), L₀, L₁ and L₂ each may have a substituent. Examples of the substituent include a halogen atom (for example, a chlorine atom, a bromine atom, and a fluorine atom), an alkyl group having 1-6 carbon atoms (for example, a methyl group, an ethyl group, a propyl group, an isopropyl group, and a butyl group), an alkoxy group having 1-6 carbon atoms (for example, a methoxy group, an ethoxy group, an n-propoxy group, an isopropoxy group, an n-butoxy group, and a tert-butoxy group), an acyl group (for example, an acetyl group, a propionyl group, and a trifluoroacetyl group), an acyloxy group (for example, an acetoxy group, a propionyloxy group, and a trifluoroacetoxy group), and an alkoxycarbonyl group (for example, a methoxycarbonyl group, an ethoxycarbonyl group, and a tert-butoxycarbonyl group). Preferred examples of the substituent include an alkyl group, an alkoxy group, and an alkoxycarbonyl group.

Preferable examples of L₀, L₁ and L₂ include divalent connecting groups, each of which may have an oxygen atom or a sulfur atom in the main chain. More preferable are divalent connecting groups having 1-5 carbon atoms, which contain only carbon atoms in the main chain.

The connecting groups, represented by L₁ and L₂, are generally shown in Formulas (A), (I), and (II). Listed below are examples of L₁ and L₂, being divalent connecting groups having 1-15 carbon atoms, which may have an oxygen atom or a sulfur atom in the main chain. These divalent groups may be combined with a plurality of groups of an —O— group, an —S— group, a —CO— group, and a —CS— group.
methylene group: —CH₂—,
ethylidene group: >CHCH₃,
isopropylidene group: >C(CH₃)₂,
1,2-ethylene group: —CH₂CH₂—,
1,2-propylene group: —CH(CH₃)CH₂—,
1,3-propanediyl group: —CH₂CH₂CH₂—,
2,2-dimethyl-1,3-propanediyl group: —CH₂C(CH₃)₂CH₂—,
2,2-dimethoxy-1,3-propanediyl group: —CH₂C(OCH₃)₂CH₂—,
2,2-dimethoxymethyl-1,3-propanediyl group: —CH₂C(CH₂OCH₃)₂CH₂—,
1-methyl-1,3-propanediyl group: —CH(CH₃)CH₂CH₂—,
1,4-butanediyl group: —CH₂CH₂CH₂CH₂—,
1,5-pantanediyl group: —CH₂CH₂CH₂CH₂CH₂—,
oxydiethylene group: —CH₂CH₂OCH₂CH₂—,
thiodiethylene group: —CH₂CH₂SCH₂CH₂—,
3-oxothiodiethylene group: —CH₂CH₂SOCH₂CH₂—,
3,3-dioxothiodiethylene group: —CH₂CH₂SO₂CH₂CH₂—,
1,4-dimethyl-3-oxa-1,5-pentanediyl group: —CH(CH₃)CH₂OCH(CH₃)CH₂—,
3-oxopentanediyl group: —CH₂CH₂COCH₂CH₂—,
1,5-dioxo-3-oxapentanediyl group: —COCH₂OCH₂CO—,
4-oxa-1,7-heptanediyl group: —CH₂CH₂CH₂OCH₂CH₂CH₂—,
3,6-dioxa-1,8-octanediyl group: —CH₂CH₂OCH₂CH₂OCH₂CH₂—,
1,4,7-trimethyl-3,6-dioxa-1,8-octanediyl group: —CH(CH₃)CH₂OCH(CH₃)CH₂OCH(CH₃)CH₂—,
5,5-dimethyl-3,7-dioxa-1,9-nonanediyl group: —CH₂CH₂OCH₂C(CH₃)₂CH₂OCH₂CH₂—,
5,5-dimethoxy-3,7-dioxa-1,9-nonanediyl group: —CH₂CH₂OCH₂C(OCH₃)₂CH₂OCH₂CH₂—,
5,5-dimethoxymethyl-3,7-dioxa-1,9-nonanediyl group: —CH₂CH₂OCH₂C(CH₂OCH₃)₂CH₂OCH₂CH₂—,
4,7-dioxo-3,8-dioxa-1,10-decanediyl group: —CH₂CH₂O—COCH₂CH₂CO—OCH₂CH₂—,
3,8-dioxo-4,7-dioxa-1,10-decanediyl group: —CH₂CH₂CO—OCH₂CH₂O—COCH₂CH₂—,
1,3-cyclopentanediyl group: -1,3-C₅H₈—
1,2-cyclohexanediyl group: -1,2-C₆H₁₀—
1,3-cyclohexanediyl group: -1,3-C₆H₁₀—
1,4-cyclohexanediyl group: -1,4-C₆H₁₀—
2,5-tetrahydrofuranediyl group: 2,5-C₄H₆O—
p-phenylene group: -p-C₆H₄—
m-phenylene group: -m-C₆H₄—
α,α′-o-xylylene group: -o-CH₂—C₆H₄—CH₂—
α,α′-m-xylylene group: -m-CH₂—C₆H₄—CH₂—
α,α′-p-xylylene group: -p-CH₂—C₆H₄—CH₂—
furane-2,5-diyl-bismethylene group: 2,5-CH₂—C₄H₂O—CH₂—,
thiophene-2,5-diyl-bismethylene group:
2,5-CH₂—C₄H₂S—CH₂—, and
isopropylidenebis-p-phenylene group: -p-C₆H₄—C(CH₃)₂-p-C₆H₄—
   Examples of the connecting groups, being trivalent or more, include groups formed by eliminating the necessary number of the hydrogen atoms, which are located in any of the positions of the above divalent connecting groups, and groups formed by combining the aforesaid connecting groups, being trivalent or more, with a plurality of groups of an —O— group, an —S— group, a —CO— group, and a —CS— group.

Specific examples of the alicyclic epoxy compounds represented by Formula (A), (I), or (II) are listed below; however, the present invention is not limited thereto.

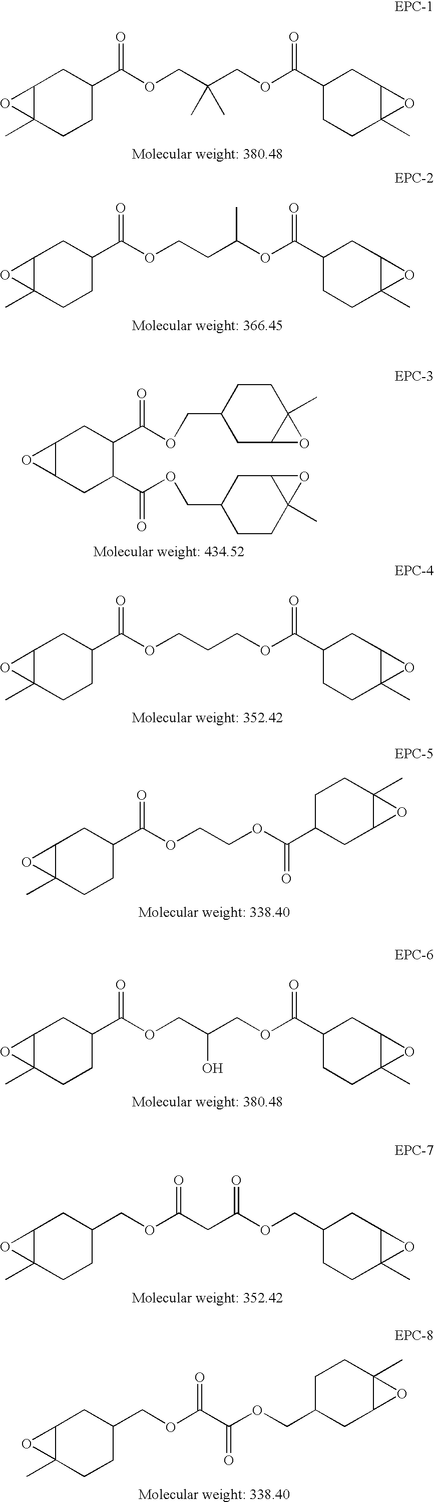

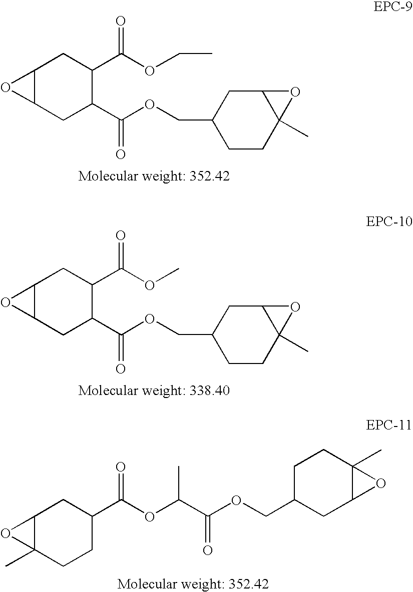

It is preferable that the added amount of a compound having an oxirane ring ranges from 10 to 80% by weight based on the total ink weight. The added amount of less than 10% by weight makes the ink unstable since curing properties markedly vary depending on curing environments (temperature and humidity). The added amount of more than 80% by weight is practically undesirable due to weakness of physical film properties after curing. To prepare the ink according to the present invention, it is possible not only to individually employ one kind of compound having an oxirane ring but also to appropriately combine two or more kinds thereof. These compounds having an oxirane ring are synthesized by referring to the following literature: Yuki Gosei (Organic Synthesis) II of Zikken Kagaku Koza (Lecture on Experimental Chemistry) 20, 4th Edition, Pages 213-, 1992, published by Maruzen Co., Ltd.; The Chemistry of Heterocyclic Compounds—Small Ring Heterocycles, Part 3, Oxiranes, edited by Alfred Hasfner, published by John & Wiley and Sons, An Interscience Publication, New York, 1985; Yoshimura, Setsuchaku (Adhesion), Vol. 29, No. 12, Page 32, 1985, Vol. 30, No. 5, Page 42, 1986, and Vol. 30, No. 7, Page 42, 1986; JP-A No. 11-100378; and Japanese Patent Publication Nos. 2906275 and 2926262.

Any photo acid generating agents known in the art are employed to cure the ink in the present invention.

Compounds, for example, used in chemically amplified photoresists, or in cationic photopolymerization may be applicable as the photo acid generating agent (refer to pages 187-192 of Imaging Yo Yuki Zairyo (Organic Materials Used for Imaging), edited by Yuki Electronics Zairyo Kenkyukai, published by Bunshin Shuppan (1993). Preferred examples according to the present invention will now be listed.

Firstly listed may be examples which include B(C₆F₅)₄⁻, PF₆⁻, AsF₆⁻, SbF₆⁻, and CF₃SO₃⁻ salts of aromatic onium compounds such as diazonium, ammonium, iodonium, sulfonium, and phosphonium.

Specific examples of the applicable onium compounds according to the present invention will now be listed.

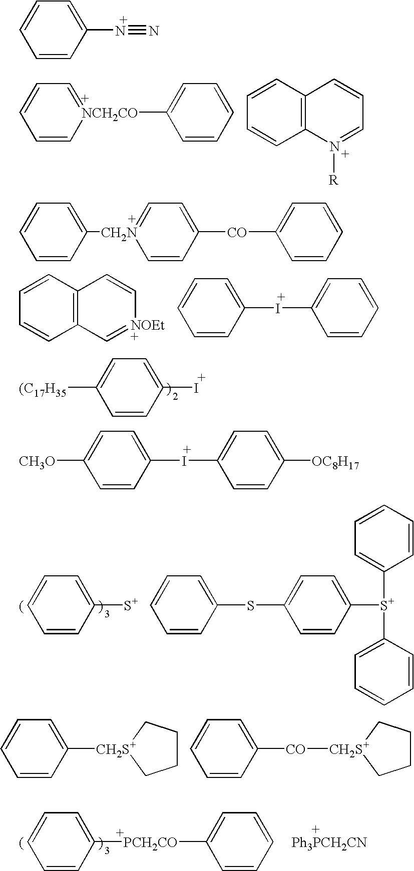

Secondly, sulfone compounds capable of generating sulfonic acid may be applicable. Specific examples will now be listed.

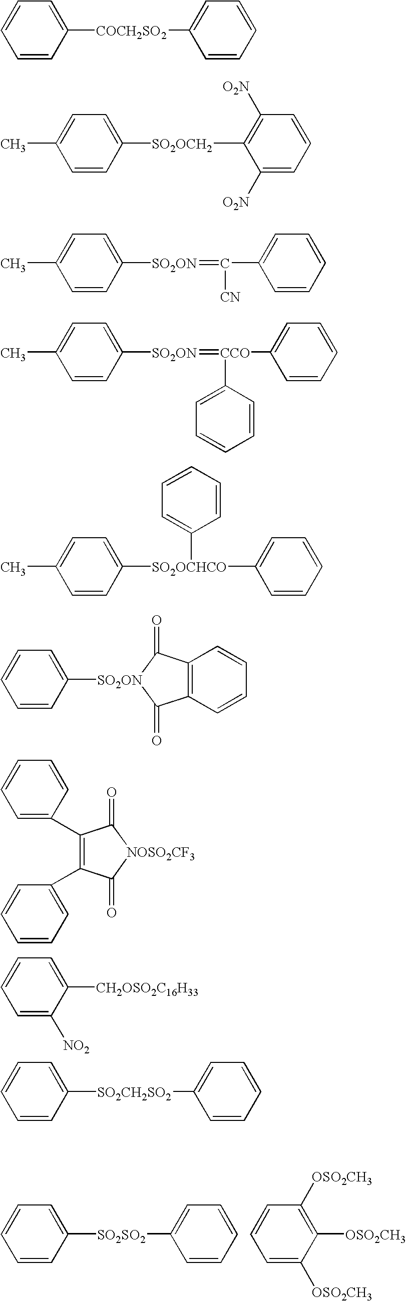

Thirdly, halogen compounds, which photolytically generate hydrogen halides, may also be applicable. Specific examples thereof will now be listed.

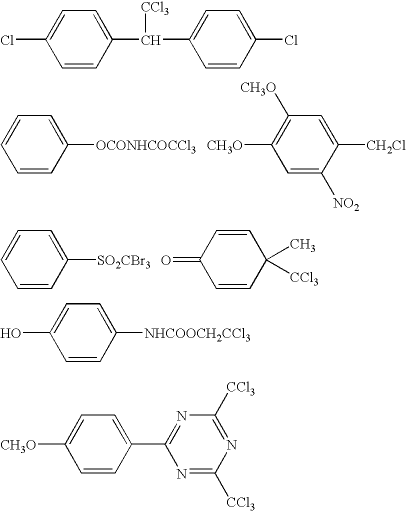

Fourthly, iron arene complexes may be applicable.

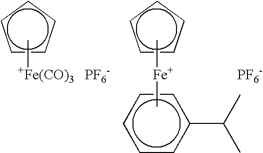

Further, preferred examples, used for preparing the ink according to the present invention, include sulfonium compounds represented by following Formulas [1]-[4], which generate no benzene via exposure to actinic radiation. The sulfonium compounds having a substituent in a benzene ring, joining a S⁺, are preferable because of satisfying the above conditions.

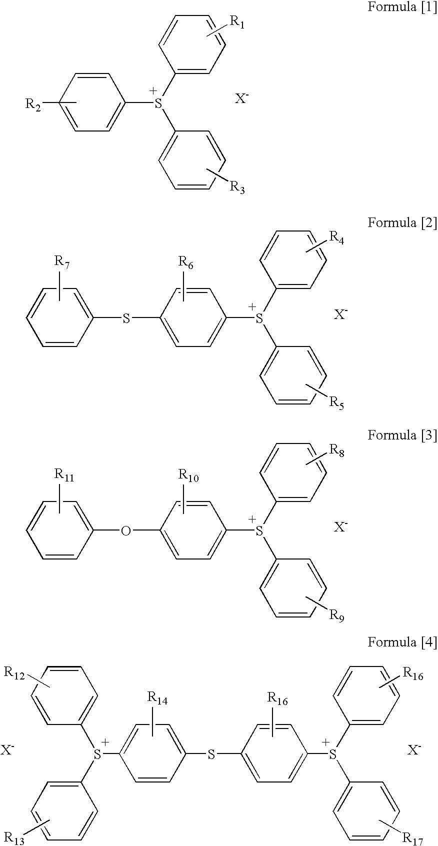

In above Formulas [1]-[4], R₁-R₁₇ are each a hydrogen atom or a substituent. R₁-R₃, R₄-R₇, R₈-R₁₁, and R₁₂-R₁₇ each are not a hydrogen atom simultaneously.

Preferred examples of the substituent represented by R₁-R₁₇ include an alkyl group (for example, a methyl group, an ethyl group, a propyl group, an isopropyl group, a butyl group, an isobutyl group, a t-butyl group, a pentyl group, and a hexyl group), an alkoxy group (for example, a methoxy group, an ethoxy group, a propoxy group, a butoxy group, a hexyloxy group, a decyloxy group, and a dodecyloxy group), a carbonyl group (for example, an acetoxy group, a propionyloxy group, a decylcarbonyloxy group, a dodecylcarbonyloxy group, a methoxycarbonyl group, an ethoxycarbonyl group, and a benzoyloxy group), a phenylthio group, a halogen atom (for example, a fluorine atom, a chlorine atom, a bromine atom, and an iodine atom), a cyano group, a nitro group, and a hydroxy group.

X is a non-nucleophilic anion residue. Examples of X include a halogen atom (for example, a fluorine atom, a chlorine atom, a bromine atom, and an iodine atom), B(C₆F₅)₄, R₁₈COO, R₁₉SO₃, SbF₆, AsF₆, PF₆, and BF₄. However, R₁₈ and R₁₉ are each an alkyl group (for example, a methyl group, an ethyl group, a propyl group, and a butyl group), a halogen atom (for example, a fluorine atom, a chlorine atom, a bromine atom, and an iodine atom), a nitro group, a cyano group, and an alkyl group or a phenyl group, which may be substituted with an alkoxy group such as a methoxy group, or an ethoxy group). Of these, B(C₆F₅)₄ and PF₆ are preferable from the viewpoint of safety.

The above compounds are readily synthesized by methods known in the art in the same manner as for photo acid generating agents described in Bulletin of the Chemical Society of Japan, Vol. 71, No. 11 (1998), and Imaging Yo Yuki Zairyo (Organic Materials Used for Imaging), edited by Yuki Electronics Zairyo Kenkyukai, published by Bunshin Shuppan (1993).

In the present invention, it is specifically preferable that the sulfonium salts represented by above Formulas [1]-[4] be at least one kind of sulfonium salt selected from following Formulas [5]-[13]. X is the non-nucleophilic anion residue as described above.

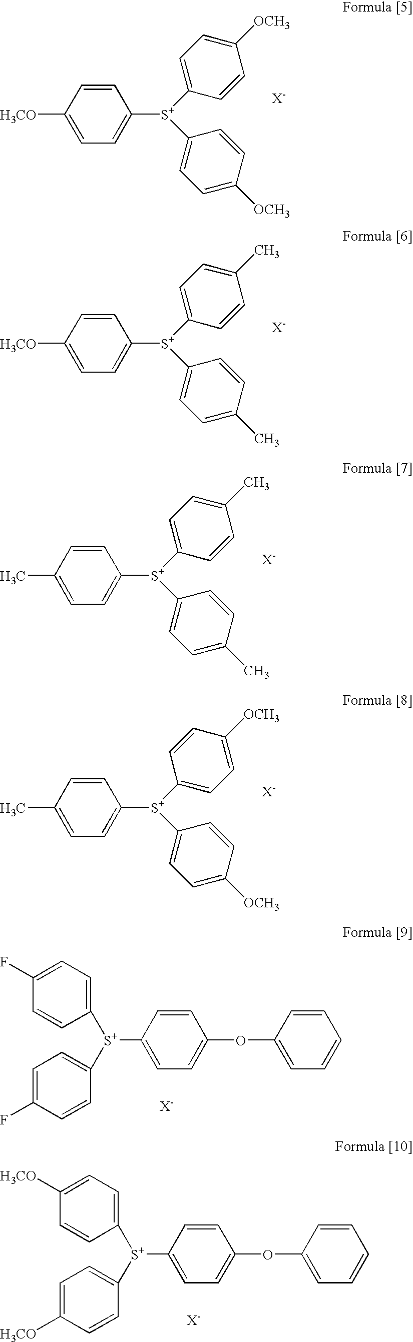

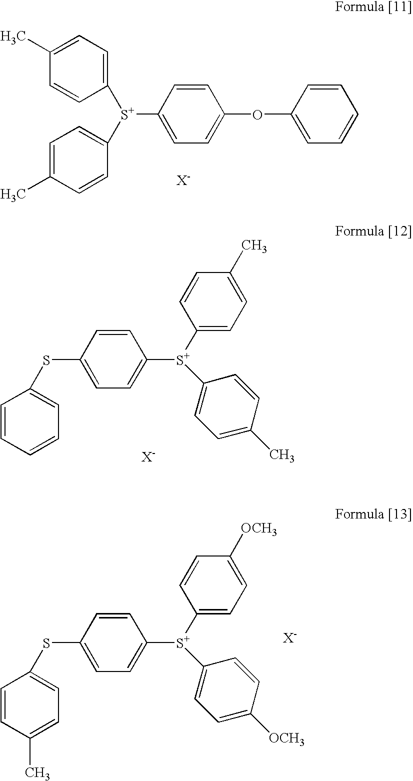

Further, to improve storage stability, any basic compounds known in the art may be used. Typical examples include basic alkali metal compounds, basic alkaline earth compounds, and basic organic compounds such as amine compounds.

Examples of the basic alkali metal compounds include alkali metal hydroxides (for example, lithium hydroxide, sodium hydroxide, and potassium hydroxide), alkali metal carbonates (for example, lithium carbonate, sodium carbonate, and potassium carbonate), and alkali metal alcoholates (for example, sodium methoxide, sodium ethoxide, potassium methoxide, and potassium ethoxide).

Examples of the basic alkaline earth metal compounds include alkaline earth metal hydroxides (for example, magnesium hydroxide and calcium hydroxide), alkaline earth metal carbonates (for example, magnesium carbonate and calcium carbonate), and alkaline earth metal alcoholates (for example, magnesium methoxide).

Examples of the basic organic compounds include nitrogen-containing heterocyclic compounds such as an amine compound, a quinoline compound, or a quinolizine compound. Of these, an amine compound is preferable from the viewpoint of compatibility with photopolymerizable monomers. Examples of the amine compound include octylamine, naphthylamine, xylenediamine dibenzylamine, diphenylamine, dibutylamine, dioctylamine, dimethylaniline, quinuclidine, tributylamine, trioctylamine, tetramethylethylenediamine, tetramethyl-1,6-hexamethylenediamine, hexamethylenetetramine, and triethanolamine.

In cases in which the basic compound is added, it is preferable that the concentration thereof ranges from 10 to 1,000 ppm by weight with respect to the total weight of a photopolymerizable monomer, but the range from 20 to 500 ppm by weight is specifically preferable. The basic compound may be used individually or in combination of a plurality of types.

Further, to inhibit curing of the ink in an ink tank, a pipe and an ink-jet head, water may also be added. The added amount of water is preferably at least 0.1%-less than 8% by weight of the total ink weight.

Further, it is possible to prepare a radical-cationic hybrid type curable ink by combining a radical polymerizable monomer and an activator.

In the present invention, it is preferable that the viscosity of the ink at 25° C. is 7-50 mPa·s from the viewpoint of realizing ejection stability from an ink-jet head and excellent curability, regardless of the curing environments (temperature and humidity).

Besides the compounds described above, various compounds may be added to the ink in the present invention, if needed. Examples include surfactants, leveling additives, matting agents, polyester based resins to control physical film properties, polyurethane resins, vinyl resins, acryl resins, gum resins and waxes.

Recording media usable for the image forming method in the present invention include various non-absorptive plastics and film for so-called soft-packaging, in addition to common non-coated and coated paper. Examples of various plastic films include PET (polyethylene terephthalate), OPS (oriented polystyrene), OPP (oriented polypropylene), ONy (oriented nylon), PVC (polyvinyl chloride), PE (polyethylene), and TAC (cellulose triacetate) films. Other usable plastics include PC (polycarbonate), acryl resins, ABS, polyacetal, PVA (polyvinyl alcohol), and rubber. Further, metals and glass may be applicable.

Heretofore, there has been a problem that the dot diameter after deposition of ink droplets varies depending on recording media since the surface energy of these various type of plastic films differs significantly. In the constitution of the present invention, it is possible to form highly detailed images on a wide range of recording media whose surface energy ranges from 35 to 60 mN/m such as OPP film and OPS film with low surface energy and PET film with relatively high surface energy.

In the present invention, in view of capability to correspond to the recording medium cost such as packaging cost or production cost, print production efficiency, and the adaptability to various size prints, the use of long-length (web) recording mediums is advantageous.

It is possible to employ the ink-jet ink of the present invention in the form of a set together with inks incorporating different colored pigments. It is preferable that the above inks are employed in the form of a set of a plurality of inks such as an ink-jet ink set composed of at least a yellow ink-jet ink, a magenta ink-jet ink, and a black ink-jet ink, which are commonly employed to prepare so-called color ink-jet prints.

Further, to form photographic images employing ink-jet printing, so-called dark and light inks, in which the content of colorants is varied in each ink, may be employed. In terms of color reproduction, if desired, it is also preferable to employ special colored inks such as red, green, blue, or white ink.

The image forming method of the present invention will now be described.

In the image forming method of the present invention, a method is preferred in which images are formed in such a manner that the ink of the present invention is ejected onto recording media employing an ink-jet recording system, and subsequently, the resulting ink is cured via exposure to actinic radiation such as UV radiation.

(Ink Layer Thickness after Deposition of Ink)

In the image forming method of the present invention, it is preferable that the total ink layer thickness after deposition of ink on a recording medium and curing via exposure to actinic radiation is preferably 2-25 μm. At present, in the actinic radiation curable ink-jet recording in the screen printing field, the total ink layer thickness exceeds 25 μm. In the soft-package printing field, in which thin plastic media are frequently employed as a recording medium, in addition to problems such as curling and wrinkling of the recording media, problems occur in which stiffness and texture of entire printed matter vary. Consequently, a large amount of ink ejection, which results in an excessively thick layer, is not preferred.

“Total ink layer thickness”, as described herein, refers to the maximum value of the ink layer thickness of the image recorded on a recording medium. The above total ink layer thickness is as defined for cases in which recording is conducted via a single color ink-jet recording system, as well as 2-color superimposition (secondary color), 3-color superimposition, and 4-color superimposition (white ink base).

(Ink Ejection Conditions)

To realize ejection stability, preferred ejection conditions are that the ink-jet recording head and ink-jet ink are heated at 35-100° C., and the ink-jet ink is ejected while heated. The actinic radiation curable ink commonly results in a wide viscosity variation depending on temperature. Viscosity variation significantly affects the size of ink droplets and the rate of droplet ejection, resulting in possible degradation of image quality. Accordingly, it is necessary to raise ink temperature and maintain the set temperature at a constant value. The ink temperature is controlled commonly within specified temperature ±5° C., preferably within specified temperature ±2° C., but still more preferably ±1° C.

Further, in the present invention, the droplet volume, ejected from each nozzle of the ink-jet recording head, is preferably 2-20 pl. In order to form highly detailed images, the droplet volume is fundamentally required to be in the above range. However, when the above droplet volume is ejected, the above ejection stability is particularly demanded. According to the present invention, even though ejection of tiny droplets, at a volume of 2-20 pl, is conducted, ejection stability is enhanced to enable stable formation of highly detailed images.

(Radiation Exposure Conditions after Deposition of Ink)

In the image forming method of the present invention, actinic radiation exposure conditions are as follows. Actinic radiation is exposed preferably 0.001-1 second after deposition of ink droplets, but is exposed more preferably 0.001-0.5 second. In order to form highly detailed images, it is particularly critical that exposure occurs as soon as possible after deposition.

The basic method of actinic radiation exposure methods is disclosed in JP-A No. 60-132767. Based on that, radiation sources are arranged on both sides of the head unit, and the head and the radiation source are scanned via a shuttle system. Exposure is conducted within a specified period after deposition of ink droplets. Further, curing is completed via another radiation source which is not driven. U.S. Pat. No. 145,979 discloses, as an exposure method, one which employ optical fibers and another in which UV radiation is exposed onto the recording section via hitting collimated radiation onto a mirror surface provided on the side of the unit. In the image forming method of the present invention, either of these exposure methods may be employed.

Further, the following method is one of the preferred embodiments. Radiation exposure is divided into two stages. Initially, actinic radiation is exposed within 0.001-2 seconds after deposition of ink droplets, and after complete printing, actinic radiation is further exposed. By dividing actinic radiation exposure into two stages, it is possible to retard contraction of the recording medium, which occurs during ink curing.

Heretofore, it has been common that a high illuminance radiation source, which consumes total power of at least 1 kW·hour, is employed to retard dot widening and bleeding after deposition of ink droplets. However, when such a radiation source is employed, particularly in shrink-label printing, the contraction of recording media is excessive, whereby it has been impossible to employ the above radiation source.

In the present invention, it is preferable to employ actinic radiation having a maximum illuminance in the wavelength region of 254 nm. Even though a radiation source is used which consumes a total power of at least 1 kW·hour, it is possible to form highly detailed images and to control the contraction of recording mediums within practically acceptable levels.

In the present invention, it is further preferable that the total consumption power of the radiation source, which emits actinic radiation, is less than 1 kW·hour. Examples of radiation sources, which consume less than 1 kW hour, include fluorescent lamps, cold-cathode tubes and LEDs; however, the present invention is not limited thereto.

The recording apparatus of the present invention will now be described while referring to appropriate drawings. The recording apparatus in the drawings is one embodiment of the present inventions, but the recording apparatus of the present invention is not limited to those in the drawings.

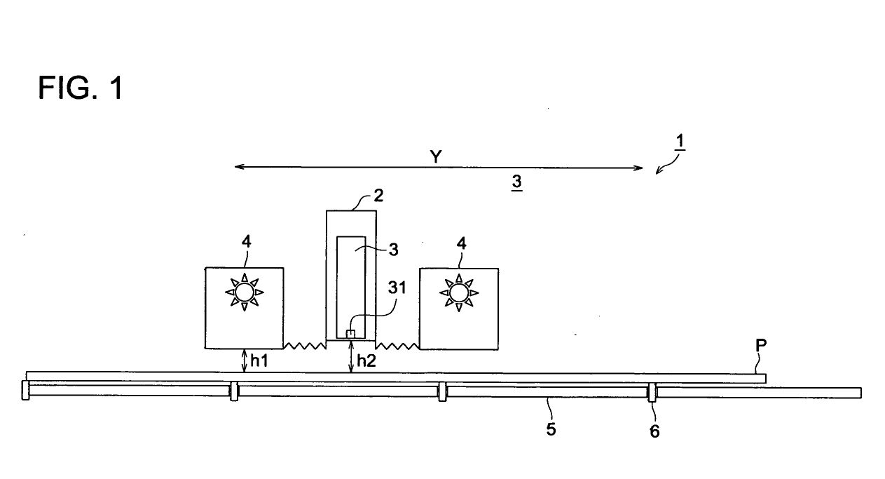

FIG. 1 is a front view showing the structure of the main section of the recording apparatus of the present invention. Recording apparatus 1 is structured of head carriage 2, ink-jet recording head 3, exposure means 4, and platen section 5. In this recording apparatus 1, platen section 5 is arranged below recording medium P. Platen section 5 functions to absorb UV radiation and absorbs excess UV radiation which has passed through recording medium P. As a result, it is possible to very stably reproduce highly detailed images.

Recording medium P is guided by guide member 6 and is conveyed from the front to the rear in FIG. 1 via the operation of a conveying means (not shown). Head scanning means (not shown) allows head carriages 2 to reciprocate in direction Y in FIG. 1, whereby scanning of recording head 3 held by carriage 2 is conducted.

Head carriage 2 is arranged above recording medium P, and a plurality of recording heads 3, described below, corresponding to the number of colors employed for image printing on recording medium P is housed while the ejection orifice is arranged in the lower side. Carriage 2 is arranged for recording apparatus 1 main body capable of realizing reciprocation in direction Y of FIG. 1, and via driving of the head scanning means, reciprocation in direction Y of FIG. 1 is conducted.

FIG. 1 is drawn so that head carriage 2 houses recording head 3. In practice, the number of colors of recording head 3 housed in head carriage 2 is appropriately determined.

Recording head 3 ejects an actinic radiation curable ink (for example, a UV curable ink) supplied by an ink supplying means (not shown) onto recording medium P via action of a plurality of ejection means (not shown) provided in the interior. The UV ink ejected from recording head 3 is composed of colorants, polymerizable monomers and initiators, and exhibits a property such that when exposed to UV radiation, the initiators function as a catalyst, whereby curing results via crosslinking and polymerization reaction of the monomers.

Ink-jet recording head 3 moves from one end of recording medium P to the other end in direction Y in FIG. 1, while driven by a scanning means. During scanning performed by the above movement, the UV ink is ejected onto specified areas (being the applicable deposition areas) on recording medium P in the form of ink droplets, and the ink droplets are deposited onto the above applicable deposition areas.

The above scanning is repeated several times as appropriate and the UV ink is ejected onto applicable deposition area 1. Thereafter, recording medium P is appropriately moved from the front to the rear in FIG. 1 via the conveying means. While repeating scanning employing the head scanning means, the actinic radiation curable ink is ejected from ink-jet recording head 3 onto the next applicable deposition area adjacent to the area on the rearward direction with respect to the above applicable deposition area in FIG. 1.

The above operation is repeated, and by ejection of the actinic radiation curable ink from recording head 3 under synchronization with the head scanning means and the conveying means, an image composed of an arrangement of UV ink droplets is formed on recording medium P.

When the actinic radiation curable ink is an ultraviolet curable ink (such as a UV ink), exposure means 4 is composed of ultraviolet lamps, which emit ultraviolet radiation of a specified wavelength at stable exposure energy, and of filters which transmit ultraviolet radiation of a specified wavelength. Usable ultraviolet lamps include mercury lamps, metal halide lamps, excimer lasers, ultraviolet lasers, cold-cathode tubes, hot-cathode tubes, blacklights, and LEDs (light emitting diodes). Of these, preferred are band shaped metal halide lamps, cold-cathode tubes, or blacklights. Due to minimization of bleeding and realization of efficient control of the dot diameter, particularly preferred are low pressure mercury lamps which emit ultraviolet radiation of a 254 nm wavelength, hot-cathode tubes, cold-cathode tubes, and sterilization lamps. It is possible to prepare exposure means 4 to cure UV ink at low cost by employing the blacklight as a radiation source of exposure means 4.

Exposure means 4 is nearly similar in size to the maximum area capable of being set by recording apparatus (being an ink-jet printer) or to be larger than the applicable deposition area of the applicable deposition area onto which the UV ink is ejected via a single scanning of recording head 3 driven by a scanning means.

Exposure means 4 is fixed on both sides of head carriage 2 to remain nearly parallel to recording medium P.

As noted above, illuminance of the ejection section is regulated, first of all, by shielding entire head 3 from light. Further, it is effective that distance h1 between exposure means 4 and recording medium P is set to be less than distance h2 between ink ejection section 31 of recording head 3, and recording medium P (namely, h1>h2), while distance d between recording head 3 and exposure means 4 is greater. Still further, it is more preferable that bellow structure 7 is arranged between recording head 3 and exposure means 4.

It is possible to appropriately change the wavelength of ultraviolet radiation emitted from exposure means 4 by replacing ultraviolet radiation lamps or filters provided with exposure means 4.

The ink of the present invention exhibits excellent ejection stability and works particularly well during formation of images employing line head type recording apparatuses.

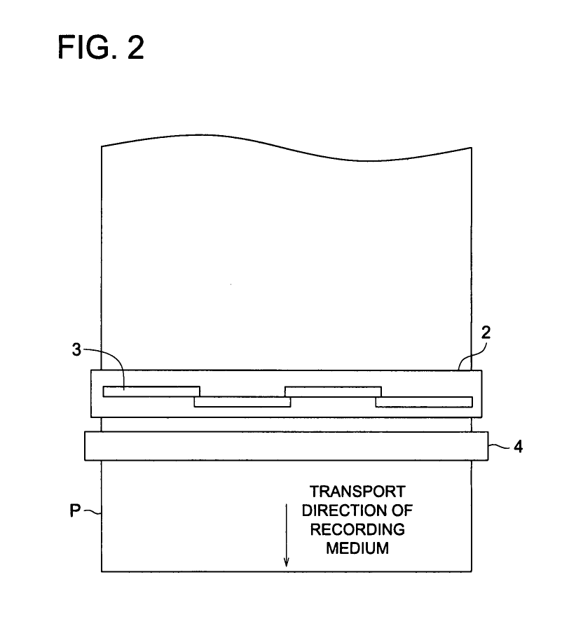

The ink-jet recording apparatus shown in FIG. 2 is called as a line head system, and a plurality of ink-jet recording heads 3, one for each color, is mounted on head carriage 2 to cover the entire width of recording medium P.

On the other hand, on the downstream side of head carriage 2, exposure means 4 is arranged to cover the entire area for ink printing so that the entire width of recording medium P is similarly covered. Employed as ultraviolet lamps employed in exposure means 4 may be any of those which are similar to those shown in FIG. 1.

In the above line head system, head carriage 2 and exposure means 4 are stationary and only recording medium P is conveyed, followed by ink ejection and curing to result in image formation.

### EXAMPLES

The present invention will now be specifically described with reference to examples; however, the present invention is not limited thereto.

<<Preparation of Pigment Dispersions>>

(Preparation of Pigment Dispersion D-1)

Each of the following compounds was placed in a stainless steel beaker, and while stirring, dissolution was conducted over three hours while heated on a hot plate at 50° C.

| | |
|---|---|
| PB822 (a dispersing agent, produced by Ajinomoto | 8 parts |
| Fine-Techno Co., Inc., at an acid value of | |
| 18.5 mg(KOH)/g and an amine value of 15.9 mg(KOH)/g | |
| OXT221 (an oxetane compound, produced by | 72 parts |
| TOAGOSEI Co., Ltd.) | |

Subsequently, after allowing the above solution to cool to room temperature, the following pigment was added, and the resulting mixture was sealed in a polypropylene vessel together with 200 g of 0.5 mm zirconia beads, followed by dispersion for 6 hours, employing a paint shaker. Thereafter, the zirconia beads were removed, whereby Pigment Dispersion D-1 was prepared.

| | |
|---|---|
| #52 (a carbon black, produced by Mitsubishi | 20 parts |
| Chemical Corp., at a pH of 8.0, being basic) | |

(Preparation of Pigment Dispersion D-2)

Each of the following compounds was placed in a stainless steel beaker, and while stirring, dissolution was conducted over three hours while heated on a hot plate at 50° C.

| | |
|---|---|
| PB821 (a dispersing agent, produced by Ajinomoto | 8 parts |
| Fine-Techno Co., Inc., at an acid value of | |
| 30.4 mg(KOH)/g and an amine value of 10.2 mg(KOH)/g | |
| OXT212 (an oxetane compound, produced by | 72 parts |
| TOAGOSEI Co., Ltd.) | |

Subsequently, after allowing the above solution to cool to room temperature, the following pigment was added, and the resulting mixture was sealed in a polypropylene vessel together with 200 g of 0.5 mm zirconia beads, followed by dispersion for 6 hours, employing a paint shaker. Thereafter, the zirconia beads were removed, whereby Pigment Dispersion D-2 was prepared.

| | |
|---|---|
| #52 (a carbon black, produced by Mitsubishi | 20 parts |
| Chemical Corp., at a pH of 8.0, being basic) | |

(Preparation of Pigment Dispersion D-3)

Each of the following compounds was placed in a stainless steel beaker, followed by mixing while stirring for one hour.

| | |
|---|---|
| DISPERBYK 161 (a dispersing agent, produced by | 20 parts |
| BYK-Chemie GmbH. at an effective component ratio | |
| of 30%, an acid value of 4.4 mg(KOH)/g, | |
| and an amine value of 10.9 mg(KOH)/g | |
| OXT221 (an oxetane compound, produced by | 60 parts |
| TOAGOSEI Co., Ltd.) | |

Subsequently, after allowing the above solution to cool to room temperature, the following pigment was added, and the resulting mixture was sealed in a polypropylene vessel together with 200 g of 0.5 mm zirconia beads, followed by dispersion for 6 hours, employing a paint shaker. Thereafter, the zirconia beads were removed, whereby Pigment Dispersion D-4 was prepared.

| | |
|---|---|
| #52 (a carbon black, produced by Mitsubishi | 20 parts |
| Chemical Corp., at a pH of 8.0, being basic) | |

(Preparation of Pigment Dispersion D-4)

Each of the following compounds was placed in a stainless steel beaker, followed by mixing while stirring for one hour.

| | |
|---|---|
| EFKA4330 (a dispersing agent, produced by EFKA | 10 parts |
| Additives B.V. at an effective component ratio | |
| of 80%, an acid value of 7.5 mg(KOH)/g, | |
| and an amine value of 30.4 mg(KOH)/g | |
| OXT221 (an oxetane compound, produced by | 70 parts |
| TOAGOSEI Co., Ltd.) | |

Subsequently, after allowing the above solution to cool to room temperature, the following pigment was added, and the resulting mixture was sealed in a polypropylene vessel together with 200 g of 0.5 mm zirconia beads, followed by dispersion for 6 hours, employing a paint shaker. Thereafter, the zirconia beads were removed, whereby Pigment Dispersion D-3 was prepared.

| | |
|---|---|
| #44 (a carbon black, produced by Mitsubishi | 20 parts |
| Chemical Corp., at a pH of 7.5, being basic) | |

(Preparation of Pigment Dispersion D-5)

Each of the following compounds was placed in a stainless steel beaker, and while stirring, dissolution was conducted over three hours while heated on a hot plate at 50° C.

| | |
|---|---|
| PB821 (a dispersing agent, produced by Ajinomoto | 8 parts |
| Fine-Techno Co., Inc., at an acid value of | |
| 30.4 mg(KOH)/g and an amine value of 10.2 mg (KOH)/g | |
| OXT221 (an oxetane compound, produced by | 72 parts |
| TOAGOSEI Co., Ltd.) | |

Subsequently, after allowing the above solution to cool to room temperature, the following pigment was added, and the resulting mixture was sealed in a polypropylene vessel together with 200 g of 0.5 mm zirconia beads, followed by dispersion for 6 hours, employing a paint shaker. Thereafter, the zirconia beads were removed, whereby Pigment Dispersion D-5 was prepared.

| | |
|---|---|
| MA11 (a carbon black, produced by Mitsubishi | 20 parts |
| Chemical Corp., at a pH of 8.0, being acidic) | |

(Preparation of Pigment Dispersion D-6)

Each of the following compounds was placed in a stainless steel beaker, followed by mixing while stirring for 3 hours.

| | |
|---|---|
| EFKA7500 (a dispersing agent, produced by EFKA | 8 parts |
| Additives B.V. at an acid value of | |
| 322 mg(KOH)/g, and an amine value of 0 mg(KOH)/g | |
| OXT221 (an oxetane compound, produced by | 72 parts |
| TOAGOSEI Co., Ltd.) | |

Subsequently, after allowing the above solution to cool to room temperature, the following pigment was added, and the resulting mixture was sealed in a polypropylene vessel together with 200 g of 0.5 mm zirconia beads, followed by dispersion for 6 hours, employing a paint shaker. Thereafter, the zirconia beads were removed, whereby Pigment Dispersion D-6 was prepared.

| | |
|---|---|
| #52 (a carbon black, produced by Mitsubishi | 20 parts |
| Chemical Corp., at a pH of 8.0, being basic) | |

<<Preparation of Inks>>

Each of the additives listed in Table 1 was sequentially mixed with each of the pigment dispersions prepared as above, and the resulting mixture was filtered through a 1.0 μm membrane filter, whereby Inks 1-17 were prepared. Numeric values listed in Table 1 represent % by weight.

TABLE 1

| | Colorant | | | | Oxirane Compound | | | | | | |
|---|---|---|---|---|---|---|---|---|---|---|---|
| | Pigment | | | | Having Oxirane Ring | | | | Photo- | | |
| | Dispersion | | Oxetane | | 1 | | 2 | | polymerization | Surface | |
| Ink | | Added | Compound | | | Added | | Added | Initiator | Active Agent | |
| No. | No. | Amount | OXT221 | OXT212 | Type | Amount | Type | Amount | SP-152 | F475 | Remarks |
| 1 | D-1 | 13.50 | 58.99 | — | EPA-7 | 27.00 | — | — | 0.50 | 0.01 | Inv. |
| 2 | D-1 | 12.00 | 56.48 | — | EPB-1 | 31.00 | — | — | 0.51 | 0.01 | Inv. |
| 3 | D-1 | 13.00 | 56.46 | — | PO | 30.00 | — | — | 0.52 | 0.02 | Inv. |
| 4 | D-1 | 14.00 | — | 54.99 | DEP | 30.50 | — | — | 0.50 | 0.01 | Inv. |
| 5 | D-1 | 12.80 | 53.72 | — | E-4030 | 33.00 | — | — | 0.48 | — | Inv. |
| 6 | D-1 | 13.20 | 58.33 | — | EPC-1 | 28.00 | — | — | 0.45 | 0.02 | Inv. |
| 7 | D-2 | 11.50 | 51.01 | 12.00 | EPD-9 | 25.00 | — | — | 0.47 | 0.02 | Inv. |
| 8 | D-2 | 13.00 | 59.50 | — | PO | 7.00 | EPC-1 | 20.00 | 0.49 | 0.01 | Inv. |
| 9 | D-2 | 12.90 | 66.14 | — | EPC-1 | 20.50 | — | — | 0.45 | 0.01 | Inv. |
| 10 | D-3 | 11.90 | 65.63 | — | EPB-1 | 22.00 | — | — | 0.45 | 0.02 | Inv. |
| 11 | D-4 | 12.20 | — | 64.32 | EPD-7 | 23.00 | — | — | 0.48 | — | Inv. |
| 12 | D-5 | 14.00 | 61.02 | — | EPB-1 | 24.50 | — | — | 0.47 | 0.01 | Comp. |
| 13 | D-5 | 13.30 | 63.69 | — | DEP | 22.50 | — | — | 0.50 | 0.01 | Comp. |
| 14 | D-5 | 12.90 | — | 60.65 | E-4030 | 26.00 | — | — | 0.45 | — | Comp. |
| 15 | D-5 | 12.90 | 64.61 | — | E-4030 | 22.00 | — | — | 0.48 | 0.01 | Comp. |
| 16 | D-6 | 13.40 | 63.38 | — | EPB-1 | 22.80 | — | — | 0.40 | 0.02 | Comp. |
| 17 | D-6 | 13.50 | 61.06 | — | E-4030 | 25.00 | — | — | 0.44 | — | Comp. |

Inv.: Present Invention, Comp.: Comparative Example

Each of the additives listed in abbreviated form in Table 1 will be detailed.

(Oxetane Compounds)

OXT-221: di[1-ethyl(3-oxetanyl)]methyl ether (produced by TOAGOSEI Co., Ltd.)
OXT-212: oxetane compound (produced by TOAGOSEI Co., Ltd.) (Epoxy Compounds: Compounds Having an Oxirane Ring)
EPA-7: Exemplified Compound EPA-7
EPB-1: Exemplified Compound EPB-1
EPC-1: Exemplified Compound EPC-1
EPD-9: Exemplified Compound EPD-9
PO: α-pinene oxide
DEP: 1,2:8,9-diepoxylimonene
E-4030: SANSOClZER E-4030 (butyl epoxidized aliphate, produced by New Japan Chemical Co., Ltd.)
   (Photo Polymerization Initiator)
SP-152: triphenylsulfonium salt (“ADEKA OPTOMER SP-152”, produced by Asahi Denka Co., Ltd.)
   (Surface Active Agent)
F475: MEGAFAX F475 acrylic oligomer having a perfluoroalkyl group (produced by Dainippon Ink and Chemicals, Inc.)
   <<Evaluation of Inks>>
   [Evaluation of Curability (Finger Touch Test)]

Each ink was applied onto a PET (polyethylene terephthalate) sheet to reach a total thickness of approximately 5 μm, followed by exposure for 30 seconds at an illuminance of 80 mW/cm² (254 nm illuminance by UVPF-A1, produced by Iwasaki Electric Co., Ltd.), employing a low pressure mercury lamp.

Subsequently, after the above exposure, the image surface was touched by a finger, and curability was evaluated based on the following criteria.
A: No stickiness was noted
B: Slight stickiness was noted
C: Stickiness was clearly noted, but was at the level such that no removal occurred during rubbing
D: curing was not realized, resulting in a flow state.
   [Formation and Evaluation of Ink-Jet Images]
   (Image Forming Method A; Ejection Capability Evaluation 1)

Immediately after ink preparation and after allowing inks to stand at 70° C. and 50% relative humidity for one week, each of Inks 1-17 was loaded in the carriage system ink-jet recording apparatus provided with a piezo type ink-jet nozzles, which was structured as shown in FIG. 1. A black solid image was printed on a 500 m long-length polyethylene terephthalate film, whereby each of the images was prepared. The ink feeding system was composed of an ink tank, a feeding pipe, a pre-chamber ink tank immediately prior to the head, a piping fitted with filters, and a piezo head. A section from the pre-chamber tank to the head portion was subjected to heat insulation and was heated to 50° C. Each ink was continuously ejected while the piezo head was operated to enable ejection of 2-20 pl multi-size dots at a resolution of 720×720 dpi. After deposition, the ink was instantaneously cured (less than 0.5 second after deposition).

After recording, the thickness of the total ink layer was determined, resulting in the range of 2.3-13 μm. As used herein, the term “dpi” is the number of dots per 2.54 cm. Each of the ink-jet images was formed at the ambience of 25° C. and 40% relative humidity, based on the above method.

(Image Forming Method B; Ejection Capability Evaluation 2)

After ink preparation and after allowing inks to stand at 70° C. and 50% relative humidity for one week, each of Inks 1-17 was loaded in the same manner as in above Forming Method A, except that the line head recording system ink-jet recording apparatus described in FIG. 2 was employed, and each image was formed.

Further, exposure radiation sources employed in each of the image forming methods will now be detailed.

Exposure radiation source employed in Recording Apparatus A: high pressure mercury lamp VZERO 085 (at a peak wavelength of 254 nm and a maximum illuminance of 400 mW/cm², manufactured by Integration Technology Co.), and Exposure radiation source employed in Recording Apparatus B: low pressure mercury lamp (customized product manufactured by Iwasaki Electric Co., Ltd., 5-lamp arrangement as a linear radiation source, at an exposure area of 120 mm (longitudinal direction)×620 mm (lateral direction), a peak wavelength of 254 nm, and a maximum illuminance of 50 mW/cm²).

Illuminance of each of the above exposure radiation sources was determined employing UVPF-A1 manufactured by Iwasaki Electric Co., Ltd. and then listed as the accumulated illuminance at 254 nm.

(Evaluation of Ejection Capability)

With regard to Ejection Capabilities 1 and 2, the boundary between the solid image printed portion and the non-printed portion of each of the formed images was visually observed and the ejection capability was evaluated based on the following criteria.
A: No disorder of the image in the boundary portions was noted.
B: Slight disorder of the boundary was noted due to bending and scattering of ink droplets.
C: Disordered boundary was noted due to bending and scattering of ink droplets.

Each of the results obtained above is shown in Table 2.

TABLE 2

| | Evaluation Result | | | | | |
|---|---|---|---|---|---|---|
| | Ejection | | Ejection | | | |
| | Capability | | Capability | | | |
| | Evaluation 1 | | Evaluation 2 | | | |
| | Soon | One Week | Soon | One Week | | |
| | after | at 70° C. | after | at 70° C. | | |
| | Ink | after Ink | Ink | after Ink | | |
| Ink | Prepa- | Prepa- | Prepa- | Prepa- | Curability | |
| No. | ration | ration | ration | ration | Evaluation | Remarks |
| 1 | A | A | A | A | A | Inv. |
| 2 | A | A | A | A | A | Inv. |
| 3 | A | A | A | A | A | Inv. |
| 4 | A | A | A | A | A | Inv. |
| 5 | A | A | A | A | A | Inv. |
| 6 | A | A | A | A | A | Inv. |
| 7 | A | A | A | A | A | Inv. |
| 8 | A | A | A | A | A | Inv. |
| 9 | A | A | A | A | A | Inv. |
| 10 | A | A | A | A | B | Inv. |
| 11 | A | B | A | B | B | Inv. |
| 12 | B | C | B | C | B | Comp. |
| 13 | B | C | B | C | B | Comp. |
| 14 | B | C | B | C | B | Comp. |
| 15 | B | C | B | C | B | Comp. |
| 16 | C | C | C | C | D | Comp. |
| 17 | C | C | C | C | D | Comp. |

Inv.: Present Invention, Comp.: Comparative Example

As can clearly be seen from the results described in Table 2, ink-jet inks according to the present invention exhibited excellent ejection capability, a high curing rate, and excellent ejection capability even after storage at a high temperature, compared to comparative examples.

1. An active ray curable ink-jet ink comprising at least a carbon black based pigment, a dispersing agent, a cationic polymerizable monomer, and an acid generating agent,
wherein the carbon black based pigment is basic, and the dispersing agent has an acid value and an amine value.

2. The active ray curable ink-jet ink described in claim 1,
wherein the acid value and amine value satisfy a condition of the following formula.
0.3≦(amine value of dispersing agent)/(acid value of dispersing agent)≦3.3

3. The active ray curable ink-jet ink described in claim 1,
wherein at least one of the cationic polymerizable monomers is a compound having an oxetane ring.

4. The active ray curable ink-jet ink described in claim 1,
wherein at least one of the cationic polymerizable monomers is a compound having an oxirane ring.

5. The active ray curable ink-jet ink described in claim 4,
wherein the compound having an oxirane ring is the compound represented by Formula (1): 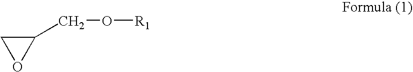
wherein R₁ is an alkyl group having 1-10 carbon atoms which may be substituted, an aromatic group which may be substituted, or an acyl group.

6. The active ray curable ink-jet ink described in claim 4,
wherein the compound having an oxirane ring is the compound represented by Formula (2): 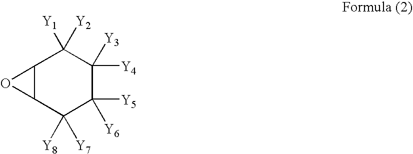
wherein Y₁-Y₈ are each a hydrogen atom, an alkyl group, a carbonyl group, or an ether group, which groups may be substituted, and Y₁-Y₈ may differ with each other.

7. The active ray curable ink-jet ink described in claim 4,
wherein the compound having an oxirane ring is α-pinene oxide.

8. The active ray curable ink-jet ink described in claim 4,
wherein the compound having an oxirane ring is 1,2:8,9-diepoxylimonene.

9. The active ray curable ink-jet ink described in claim 4,
wherein the compound having an oxirane ring is epoxidized vegetable oil having an unsaturated bond.

10. The active ray curable ink-jet ink described in claim 4,
wherein the compound having an oxirane ring is the compound represented by Formula (A): 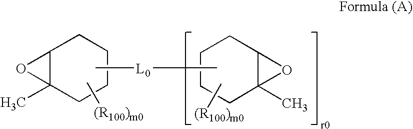
wherein R₁₀₀ is a substituent, m0 is 0-2, r0 is 1-3, and L₀ are each an r0+1 valent linking group having 1-15 carbon atoms, which may incorporate an oxygen atom or a sulfur atom in the primary chain, or a single bond group.

11. An image forming method comprising the steps of:
(a) ejecting the active ray curable ink-jet ink described in claim 1 onto a recording medium from an ink-jet recording head, and
(b) curing the ejected ink-jet ink to form an image onto the recording medium,
wherein actinic rays are exposed during 0.001-1 second after the active ray curable ink-jet ink is deposited onto the recording medium.

12. The image forming method described in claim 11,
wherein actinic rays are exposed after the active ray curable ink-jet ink is deposited onto the recording medium, and a total thickness of an ink layer after curing is 2-25 μm.

13. The image forming method described in claim 11,
wherein the droplet volume of the active ray curable ink-jet ink ejected from each nozzle of the ink-jet recording head is 2-20 pl.

14. The image forming method described in claim 11,
wherein the ink-jet recording head is a line head system.

15. An ink-jet recording apparatus which is employed in the image forming method described in claim 11,
wherein the active ray curable ink-jet ink is ejected after the active ray curable ink-jet ink and the ink-jet recording head are heated at 35-100° C.
